(19) United States
(12) Patent Application Publication
(10) Pub. No.: US 2021/0288323 A1
(43) Pub. Date: Sep. 16, 2021

(54) NON-AQUEOUS ELECTROLYTE SECONDARY BATTERY NEGATIVE ELECTRODE MATERIAL, NON-AQUEOUS ELECTROLYTE SECONDARY BATTERY NEGATIVE ELECTRODE INCLUDING THE NEGATIVE ELECTRODE MATERIAL AND NON-AQUEOUS ELECTROLYTE SECONDARY BATTERY INCLUDING THE NEGATIVE ELECTRODE

(71) Applicant: HONDA MOTOR CO., LTD., Tokyo (JP)

(72) Inventors: Makiko TAKAHASHI, Saitama (JP); Tomohiro KINOSHITA, Saitama (JP); Kiyoshi TANAAMI, Saitama (JP); Shintaro AOYAGI, Saitama (JP); Takashi MUKAI, Osaka (JP); Yuta IKEUCHI, Osaka (JP); Taichi SAKAMOTO, Osaka (JP); Naoto YAMASHI TA, Osaka (JP)

(21) Appl. No.: 17/196,985

(22) Filed: Mar. 9, 2021

(30) Foreign Application Priority Data
Mar. 13, 2020 (JP) 2020-044796

(51) Int. Cl. H01M 4/58

(52) U.S. Cl. CPC H01M 4/5825; H01M 2004/027

(57) ABSTRACT

An object is to provide a non-aqueous electrolyte secondary battery negative electrode material which can improve a battery life as compared with a conventional one, a non-aqueous electrolyte secondary battery negative electrode including such a negative electrode material and a non-aqueous electrolyte secondary battery including such a negative electrode. A non-aqueous electrolyte secondary battery negative electrode material that includes a negative electrode active material formed of a silicon-based material a skeleton-forming agent including a silicate having a siloxane bond and an interface layer formed in an interface between the negative electrode active material and the skeleton-forming agent and formed of an inorganic material, a non-aqueous electrolyte secondary battery negative electrode including it and a non-aqueous electrolyte secondary battery are provided.

This application is based on and claims the benefit of priority from Japanese Patent Application No. 2020-044796, filed on 13 Mar. 2020, the content of which is incorporated herein by reference.

### BACKGROUND OF THE INVENTION

### Field of the Invention

The present invention relates to a non-aqueous electrolyte secondary battery negative electrode and a non-aqueous electrolyte secondary battery including the same.

### Related Art

In recent years, since non-aqueous electrolyte secondary batteries such as a lithium-ion secondary battery have been small and lightweight and have produced a high output, they have been increasingly used for automobiles and the like. The non-aqueous electrolyte secondary battery is a generic name for a battery system that uses, as its electrolyte, an electrolyte whose main component is not water and an electricity storage device that can be charged and discharged. For example, a lithium-ion battery, a lithium-polymer battery, a lithium all-solid-state battery, a lithium-air battery, a lithium-sulfur battery, a sodium-ion battery, a potassium-ion battery, a polyvalent ion battery, a fluoride battery, a sodium-sulfur battery and the like are known. The non-aqueous electrolyte secondary battery is mainly formed with a positive electrode, a negative electrode and an electrolyte. When the electrolyte has fluidity, a separator is further interposed between the positive electrode and the negative electrode.

Incidentally, in the non-aqueous electrolyte secondary battery described above, its battery life is required to be improved. Hence, a technology is disclosed in which a skeleton-forming agent including a silicate having a siloxane bond is made to exist on at least the surface of an active material layer and in which the skeleton-forming agent is made to penetrate from the surface thereinto (see, for example, Patent Document 1). It is disclosed that, with this technology, a strong skeleton can be formed in the active material layer so as to improve the battery life. A technology is also disclosed in which the skeleton-forming agent described above is applied to a negative electrode including a silicon (Si)-based active material (see, for example, Patent Document 2).
Patent Document 1: Japanese Patent No. 6369818
Patent Document 2: Japanese Patent No. 6149147

### SUMMARY OF THE INVENTION

However, it is likely that, with the technologies of Patent Documents 1 and 2, a sufficient battery life cannot be obtained for a long period of time, and thus it is desirable to further improve a battery life.

The present invention is made in view of the situation described above, and an object thereof is to provide a non-aqueous electrolyte secondary battery negative electrode material which can improve a battery life as compared with a conventional one, a non-aqueous electrolyte secondary battery negative electrode including such a negative electrode material and a non-aqueous electrolyte secondary battery including such a negative electrode.

(1) In order to achieve the object described above, the present invention provides a non-aqueous electrolyte secondary battery negative electrode material including: a silicon-based material; a skeleton-forming agent including a silicate having a siloxane bond; and an interface layer formed in an interface between the silicon-based material and the skeleton-forming agent and formed of an inorganic material.

(2) In the non-aqueous electrolyte secondary battery negative electrode material of (1), the skeleton-forming agent may include the silicate represented by general formula (1) below, and the interface layer may include silicon and an alkali metal.

[Chem. 1]

A₂O.nSiO₂ formula (1)

[In the general formula (1) above, A represents an alkali metal.]

(3) In the non-aqueous electrolyte secondary battery negative electrode material of (1) or (2), a ratio of alkali metal atoms to all constituent atoms of the interface layer may be higher than a ratio of alkali metal atoms to all constituent atoms of the skeleton-forming agent.

(4) In the non-aqueous electrolyte secondary battery negative electrode material of (3), the ratio of the alkali metal atoms to all the constituent atoms of the interface layer may be five or more times as high as the ratio of the alkali metal atoms to all the constituent atoms of the skeleton-forming agent.

(5) In the non-aqueous electrolyte secondary battery negative electrode material of any one of (1) to (4), the thickness of the interface layer may be 3 to 30 nm.

(6) The present invention provides a non-aqueous electrolyte secondary battery negative electrode including the non-aqueous electrolyte secondary battery negative electrode material of any one of (1) to (5).

(7) The present invention also provides a non-aqueous electrolyte secondary battery including the non-aqueous electrolyte secondary battery negative electrode of (6).

According to the present invention, it is possible to provide a non-aqueous electrolyte secondary battery negative electrode material which can improve a battery life as compared with a conventional one, a non-aqueous electrolyte secondary battery negative electrode including such a negative electrode material and a non-aqueous electrolyte secondary battery including such a negative electrode.

### BRIEF DESCRIPTION OF THE DRAWINGS

FIG. 1 is a TEM image of a negative electrode in Example 3;

FIG. 2 is an enlarged view of an interface between a negative electrode active material and a skeleton-forming agent in FIG. 1;

FIG. 3 is an EDX spectrum diagram of a negative electrode in Example 1;

FIG. 4 is an EDX spectrum diagram of a negative electrode in Example 4;

FIG. 5 is an EDX spectrum diagram of a negative electrode in Comparative Example 4;

FIG. 6 is an EDX mapping diagram of the negative electrode in Example 1; and

FIG. 7 is an EDX mapping diagram of the negative electrode in Comparative Example 4.

### DETAILED DESCRIPTION OF THE INVENTION

Embodiments of the present invention will be described in detail below.

### First Embodiment

### [Negative Electrode Material]

A non-aqueous electrolyte secondary battery negative electrode material according to the present embodiment includes: a silicon-based material; a skeleton-forming agent including a silicate having a siloxane bond; and an interface layer formed in an interface between the silicon-based material and the skeleton-forming agent and formed of an inorganic material. For example, a lithium-ion secondary battery negative electrode including the negative electrode material of the present embodiment can provide a lithium-ion secondary battery negative electrode which has a high strength, excellent heat resistance and a high capacity and whose cycle life characteristics are improved and a lithium-ion secondary battery including it. Although an example where the present embodiment is applied to the lithium-ion secondary battery negative electrode will be described in detail below, various additions, modifications or deletions can be made without departing from the spirit of the present invention.

As the negative electrode active material of the present embodiment, the silicon-based material is used. The silicon-based material can reversibly store and release lithium ions, and functions as the negative electrode active material. Specifically, the silicon-based material is a negative electrode material in which silicon is an essential element, and elemental silicon, a silicon alloy, a silicon oxide, a silicon compound and the like apply. Here, the elemental silicon refers to crystalline or amorphous silicon whose purity is equal to or greater than 95% by mass. The silicon alloy means a Si—M alloy formed of silicon and another transition element (M), examples of M include Al, Mg, La, Ag, Sn, Ti, Y, Cr, Ni, Zr, V, Nb, Mo and the like and the silicon alloy may be an all-proportional solid solution alloy, a eutectic alloy, a hypoeutectic alloy, a hypereutectic alloy or a peritectic alloy. The silicon oxide means an oxide of silicon or a complex formed of elemental silicon and SiO₂, and in the elemental ratio of Si and O, O is preferably equal to or less than 1.7 with the assumption that Si is 1. The silicon compound refers to a substance in which silicon and two or more types of other elements are chemically bonded together. Among them, the elemental silicon is preferable because an interface layer which will be described later can be satisfactorily formed.

Two or more types of silicon-based materials described above may be used or a mixture or complex including the silicon-based material may be used. When a mixture or complex is formed, the silicon-based material may be mixed or complexed with a known material which is used as a non-aqueous electrolyte secondary battery negative electrode material.

The shape of the silicon-based material is not particularly limited, and the silicon-based material may be spherical, oval, faceted, band-shaped, fibrous, flaky, donut-shaped or hollow powder.

With respect to the particle diameter of the silicon-based material, when an active material powder whose particle diameter is small is used, the collapse of the particles is reduced, with the result that the life characteristics of the electrode tend to be improved. There is also a tendency that a specific surface area is increased to improve output characteristics.

For example, it is possible to present a negative electrode material using nanogranules in which the skeleton-forming agent of the present embodiment is used as a binding agent for granulation. The active material on the order of nanometers is granulated with the skeleton-forming agent, and thus stress applied to a collector caused by the expansion and contraction of the negative electrode material is suppressed, with the result that the deformation, destruction and the like of the collector can be prevented.

As the skeleton-forming agent of the present embodiment, a skeleton-forming agent including a silicate having a siloxane bond is used. More specifically, the skeleton-forming agent preferably includes a silicate represented by general formula (1) below.

[Chem. 2]

A₂O.nSiO₂ formula (1)

In general formula (1) above, A represents an alkali metal. In particular, at least one type of lithium (Li), sodium (Na) and potassium (K) is preferable as A. As the skeleton-forming agent, the alkali metal salt of a silicate having a siloxane bond as described above is used, and thus a lithium-ion secondary battery which has a high strength, excellent heat resistance and an excellent cycle life is obtained.

In general formula (1) above, n is preferably equal to or greater than 1.6 and equal to or less than 3.9. In a case where n is within the range described above, when the skeleton-forming agent is mixed with water to form a skeleton-forming agent liquid, moderate viscosity is obtained, and when it is applied as the negative electrode active material to the negative electrode including silicon as will be described later, the skeleton-forming agent easily penetrates into the negative electrode. Hence, the lithium-ion secondary battery which has a high strength, excellent heat resistance and an excellent cycle life can be more reliably obtained. More preferably, n is equal to or greater than 2.0 and equal to or less than 3.5.

The silicate described above is preferably amorphous. The amorphous silicate has a disordered molecular arrangement so as not to crack in a specific direction like a crystal. Hence, the amorphous silicate is used as the skeleton-forming agent, and thus the cycle life characteristics of the negative electrode are improved.

The skeleton-forming agent of the present embodiment may include a surfactant. In this way, the lyophilic property of the skeleton-forming agent into the negative electrode is improved, and thus the skeleton-forming agent uniformly penetrates into the negative electrode. Hence, a uniform skeleton is formed in the active material layer within the negative electrode, and thus the cycle life characteristics are more improved.

As the surfactant, a nonionic surfactant, an anionic surfactant, a cationic surfactant, an amphoteric surfactant and the like can be used. When the total solid content of the skeleton-forming agent is assumed to be 100% by mass, a content of the surfactant is preferably 0 to 5% by mass.

In the present embodiment, a ratio of alkali metal atoms to all constituent atoms of the interface layer is preferably higher than a ratio of alkali metal atoms to all constituent atoms of the skeleton-forming agent. More specifically, the ratio of the alkali metal atoms to all the constituent atoms of the interface layer is preferably five or more times as high as the ratio of the alkali metal atoms to all the constituent atoms of the skeleton-forming agent. In this way, the negative electrode active material and the skeleton-forming agent are more firmly bonded together, and thus a variation in volume caused by the expansion and contraction of the negative electrode active material at the time of charging and discharging is suppressed. Hence, in the negative electrode using this as the negative electrode material, peeling caused by the expansion and contraction of the negative electrode material at the time of charging and discharging and the occurrence of a wrinkle or a crack of the collector are more suppressed, with the result that the cycle life is more improved.

In the present embodiment, the thickness of the interface layer described above is preferably 3 to 30 nm. When the thickness of the interface layer is within this range, the silicon-based material and the skeleton-forming agent are more firmly bonded together, and thus peeling caused by the expansion and contraction of the negative electrode material at the time of charging and discharging and the occurrence of a wrinkle or a crack of the collector are more suppressed, with the result that the cycle life is more improved.

Preferably, as the specific surface area of the silicon-based material is increased, a content of the skeleton-forming agent in the negative electrode material is increased. For example, when the specific surface area of the silicon-based material is 0.1 to 50 m²/g, the content of the skeleton-forming agent in the negative electrode material is preferably 0.05 to 2.0 mg/g. The content of the skeleton-forming agent in the negative electrode material is within this range, and thus the effects produced with the use of the skeleton-forming agent described above are more reliably achieved.

The negative electrode material described above refers to a material which forms the negative electrode. Although examples of the material forming the negative electrode include an active material, a conductivity aid, a binder, a collector and other materials, the active material is preferably used.

The median diameter (D50) of the negative electrode material described above is preferably equal to or greater than 0.01 μm and equal to or less than 20 μm, more preferably equal to or greater than 0.05 μm and equal to or less than 10 μm, further preferably equal to or greater than 0.1 μm and equal to or less than 8 μm and most preferably equal to or greater than 0.15 μm and equal to or less than 6 μm. The median diameter (D50) of a complexed powder is within this range, and thus it is possible to provide an electrode material with which an electrode having excellent output characteristics and cycle life characteristics can be obtained. The median diameter is equal to or greater than 0.1 μm, and thus the specific surface area is prevented from being excessively increased, with the result that only a small amount of binder necessary for the formation of the electrode is needed. Consequently, the output characteristics and the energy density of the electrode are excellent. The median diameter is equal to or less than 20 μm, and thus the surface area of the particles is increased, and thus practical input/output characteristics are obtained.

Here, the median diameter (D50) refers to a particle diameter in which a cumulative frequency obtained by volume conversion based on volume using a laser diffraction/scattering particle diameter distribution measurement method is 50%, and the particle diameter in the present application means this median diameter (D50).

The skeleton-forming agent of the present embodiment may include a conductivity aid. The conductivity aid is not particularly limited as long as the conductivity aid has electron conductivity, and a known material can be used. Specifically, the same materials as various types of conductivity aids included in the negative electrode which will be described later can be used.

The negative electrode material described above includes, in one particle of its powder, the silicon-based material, the skeleton-forming agent including a silicate having a siloxane bond and the interface layer formed in the interface between the silicon-based material and the skeleton-forming agent and formed of the inorganic material. The particle described above has a structure in which the skeleton-forming agent including the silicate having the siloxane bond is carried on the surface of the silicon-based material or the surface is coated with the skeleton-forming agent.

For example, a configuration may be adopted in which, with the silicon-based material serving as a core, the skeleton-forming agent including the silicate having the siloxane bond is carried on the surface thereof or the surface is coated with the skeleton-forming agent, and in which the interface layer formed of the inorganic material is further provided in the interface between the silicon-based material and the skeleton-forming agent. The carrying or the coating means that the surface of the silicon-based material is partially or fully coated with the silicate.

The particle described above is preferably a particle existing in a state where the silicate serves as a matrix and where the silicon-based material is dispersed in the matrix.

The complexing in the present application is a conception different from the mixing, and the mixed powder is simply an aggregate of the silicon-based material and the silicate whereas the complexed powder includes, in one particle of the powder, both the silicon-based material and the silicate.

The negative electrode material described above is mainly used as the active material. The active material refers to a material which can electrochemically store and release ions (carriers) responsible for electrical conductivity.

The negative electrode material described above is used as a negative electrode material for the non-aqueous electrolyte secondary battery and is formed to coat the top of the collector, and thus the negative electrode material can be made to satisfactorily function as the negative electrode for the non-aqueous electrolyte secondary battery.

The negative electrode may contain, in addition to the negative electrode material of the present embodiment, for example, as necessary, the conductivity aid for providing conductivity and the binder for providing a binding property. Even when the conductivity aid, the skeleton-forming agent and the like are included in the negative electrode material, the conductivity aid, the skeleton-forming agent and the like may be further included.

For example, a solvent (such as N-methyl-2-pyrrolidone (NMP), water, alcohol, xylene or toluene) is used to form a negative electrode material-containing composition in slurry form, and the composition is applied and dried on the surface of the collector and is further pressed to form a negative electrode material-containing layer on the surface of the collector so as to be used as the negative electrode.

When the negative electrode material described above is used as the negative electrode active material such that the total solid content of the negative electrode active material, the skeleton-forming agent, the binder and the conductivity aid is 100, by mass, the content of the skeleton-forming agent is preferably 0.1 to 30% by mass. The content of the skeleton-forming agent is within this range, and thus the effects produced with the use of the skeleton-forming agent described above are more reliably achieved. The content of the skeleton-forming agent is more preferably 0.2 to 20% by mass and is further preferably 0.5 to 10% by mass.

The lithium-ion secondary battery negative electrode according to the present embodiment preferably includes the conductivity aid. The conductivity aid is not particularly limited as long as the conductivity aid has electron conductivity, and a metal, a carbon material, a conductive polymer, conductive glass and the like can be used. Specific examples thereof include acetylene black (AB), ketjen black (KB), furnace black (FB), thermal black, lamp black, channel black, roller black, disc black, carbon black (CB), carbon fiber (for example, vapor growth carbon fiber VGCF (registered trademark)), carbon nanotube (CNT), carbon nanohorn, graphite, graphene, glassy carbon, amorphous carbon and the like, and one or two or more types thereof can be used.

When the total of the negative electrode active material, the binder and the conductivity aid contained in the negative electrode is assumed to be 100% by mass, a content of the conductivity aid is preferably 0 to 20% by mass. The content of the conductivity aid is within this range, and thus conductivity can be improved without a negative electrode capacity density being lowered. As in a second embodiment which will be described later, the skeleton-forming agent may be further included as an electrode.

The lithium-ion secondary battery negative electrode according to the present embodiment may include the binder. As the binder, for example, one type of organic materials such as polyvinylidene fluoride (PVdF), polytetrafluoroethylene (PTFE), polyimide (PI), polyamide, polyamideimide, aramid, polyacrylic, styrene butadiene rubber (SBR), ethylene-vinyl acetate copolymer (EVA), styrene-ethylene-butylene-styrene copolymer (SEBS), carboxymethyl cellulose (CMC), xanthan gum, polyvinyl alcohol (PVA), ethylene vinyl alcohol, polyvinyl butyral (PVB), polyethylene (PE), polypropylene (PP), polyacrylic acid, lithium polyacrylate, sodium polyacrylate, potassium polyacrylate, ammonium polyacrylate, methyl polyacrylate, ethyl polyacrylate, amine polyacrylate, polyacrylic acid ester, epoxy resin, polyethylene terephthalate (PET), polybutylene terephthalate (PBT), nylon, vinyl chloride, silicone rubber, nitrile rubber, cyanoacrylate, urea resin, melamine resin, phenol resin, latex, polyurethane, silylated urethane, nitrocellulose, dextrin, polyvinylpyrrolidone, vinyl acetate, polystyrene, chloropropylene, resorcinol resin, polyaromatic, modified silicone, methacrylic resin, polybutene, butyl rubber, 2-propenic acid, cyanoacrylic acid, methyl methacrylate, glycidyl methacrylate, acrylic oligomer, 2-hydroxyethyl acrylate, alginic acid, starch, lacquer, sucrose, glue, casein and cellulose nanofiber may be used singly or two or more types thereof may be used together.

Binders obtained by mixing the various types of organic binders described above and inorganic binders may be used. As the inorganic binder, silicate-based, phosphate-based, sol-based, cement-based binders and the like are mentioned. For example, one type of inorganic materials such as lithium silicate, sodium silicate, potassium silicate, cesium silicate, guanidine silicate, ammonium silicate, fluosilicic salt, borate, lithium aluminate, sodium aluminate, potassium aluminate, aluminosilicate, lithium aluminate, sodium aluminate, potassium aluminate, polyaluminum chloride, aluminum polysulfate, aluminum silicate polysulfate, aluminum sulfate, aluminum nitrate, ammonium alum, lithium alum, sodium alum, potassium alum, chrome alum, iron alum, manganese alum, nickel ammonium sulfate, diatomaceous soil, polyzirconoxane, polytantaroxane, mullite, white carbon, silica sol, colloidal silica, fumed silica, alumina sol, colloidal alumina, fumed alumina, zirconia sol, colloidal zirconia, fumed zirconia, magnesia sol, colloidal magnesia, fumed magnesia, calcia sol, colloidal calcia, fumed calcia, titania sol, colloidal titania, fumed titania, zeolite, silicoaluminophosphate zeolite, sepiolite, montmorillonite, kaolin, saponite, aluminum phosphate salt, magnesium phosphate salt, calcium phosphate salt, iron phosphate salt, copper phosphate salt, zinc phosphate salt, titanium phosphate salt, manganese phosphate salt, barium phosphate salt, tin phosphate salt, low melting point glass, mortar, plaster, magnesium cement, litharge cement, portoland cement, blast furnace cement, fly ash cement, silica cement, phosphate cement, concrete and solid electrolyte may be used singly or two or more types thereof may be used together.

The collector used in the negative electrode formed of the negative electrode material according to the present embodiment is not particularly limited as long as the collector has electron conductivity and is a material capable of energizing the negative electrode active material which is held. For example, conductive substances such as C, Ti, Cr, Ni, Cu, Mo, Ru, Rh, Ta, W, Os, Ir, Pt, Al and Au and alloys (for example, stainless steel) containing two or more types of these conductive substances can be used. When a substance other than the conductive substances described above is used, for example, a multilayer structure of different metals such as a multilayer structure obtained by coating iron with Cu or Ni may be used.

In terms of high electrical conductivity and high stability in electrolytic liquid, C, Ti, Cr, Au, Fe, Cu, Ni, stainless steel and the like are preferable as the collector, and furthermore, in terms of reduction resistance and the material cost, C, Cu, Ni, stainless steel and the like are preferable. When iron is used as a collector base material, in order to prevent the oxidation of the surface of the collector base material, a collector coated with Ni or Cu is preferable.

Examples of the shape of the collector include a linear shape, a rod shape, a plate shape, a foil shape and a porous shape, and, among them, since a filling density can be increased and the skeleton-forming agent easily penetrates into the active material layer, the collector may have a porous shape. Examples of the porous shape include a mesh, a woven fabric, a non-woven fabric, an embossed material, a punched material, an expanded material, a foamed material and the like.

As described above, the first embodiment is characterized in that the non-aqueous electrolyte secondary battery negative electrode material which includes the silicon-based material, the skeleton-forming agent including the silicate having the siloxane bond and the interface layer formed in the interface between the negative electrode active material and the skeleton-forming agent and formed of the inorganic material is manufactured and that this is used as the negative electrode material.

### Second Embodiment

### [Negative Electrode]

Although the second embodiment of the present invention will then be described in detail, since terms (such as the skeleton-forming agent and the interface layer) common to the first embodiment are the same as in the first embodiment, they will be omitted as necessary unless otherwise described. Although the second embodiment is the same as in the first embodiment in that in the lithium-ion secondary battery negative electrode of the second embodiment, the negative electrode material of the first embodiment is included in the negative electrode, the second embodiment differs from the first embodiment in that the skeleton-forming agent liquid described previously is applied to the negative electrode including the silicon-based material as the negative electrode active material and that thus the skeleton-forming agent is made to penetrate into the negative electrode active material. It is estimated that when the skeleton-forming agent penetrates into the negative electrode active material, the silicon-based material forming the negative electrode active material and the silicate forming the skeleton-forming agent are melted together, for example, the hydrolyzed silicate is heated to undergo a hydration reaction (condensation reaction of silanol groups) so as to form a siloxane bond (—Si—O—Si). In other words, in the lithium-ion secondary battery negative electrode of the present embodiment, on the interface between the negative electrode active material and the skeleton-forming agent, the interface layer formed of the inorganic material is formed, and the interface layer includes the silicon derived from the siloxane bond and the alkali metal generated, for example, by the hydrolysis of the silicate. Then, it is estimated that, by the existence of the interface layer, the negative electrode active material and the skeleton-forming agent are firmly bonded together, and that consequently, excellent cycle life characteristics are obtained.

In the present embodiment, the ratio of the alkali metal atoms to all the constituent atoms of the interface layer is preferably higher than the ratio of the alkali metal atoms to all the constituent atoms of the skeleton-forming agent. More specifically, the ratio of the alkali metal atoms to all the constituent atoms of the interface layer is preferably five or more times as high as the ratio of the alkali metal atoms to all the constituent atoms of the skeleton-forming agent. In this way, the negative electrode active material and the skeleton-forming agent are more firmly bonded together, and thus peeling caused by the expansion and contraction of the negative electrode active material at the time of charging and discharging and the occurrence of a wrinkle or a crack of the collector are more suppressed, with the result that the cycle life is more improved.

In the present embodiment, the thickness of the interface layer described above is preferably 3 to 30 nm. When the thickness of the interface layer is within this range, the negative electrode active material and the skeleton-forming agent are more firmly bonded together, and thus peeling caused by the expansion and contraction of the negative electrode active material at the time of charging and discharging and the occurrence of a wrinkle or a crack of the collector are more suppressed, with the result that the cycle life is more improved.

A content (density) of the skeleton-forming agent in the negative electrode is preferably 0.1 to 1.0 mg/cm². The content of the skeleton-forming agent in the negative electrode is within this range, and thus the effects produced with the use of the skeleton-forming agent described above are more reliably achieved.

When the total solid content of the negative electrode active material, the skeleton-forming agent, the binder and the conductivity aid is assumed to be 100% by mass, the content of the skeleton-forming agent is preferably 0.1 to 30% by mass. The content of the skeleton-forming agent is within this range, and thus the effects produced with the use of the skeleton-forming agent described above are more reliably achieved. The content of the skeleton-forming agent is more preferably 0.2 to 20% by mass and is further preferably 0.5 to 10% by mass.

The lithium-ion secondary battery negative electrode according to the present embodiment preferably includes the conductivity aid. The conductivity aid is not particularly limited as long as the conductivity aid has electron conductivity, and a metal, a carbon material, a conductive polymer, conductive glass and the like can be used. Specifically, the various types of materials described in the first embodiment can be used.

When the total of the negative electrode active material, the binder and the conductivity aid contained in the negative electrode is assumed to be 100% by mass, a content of the conductivity aid is preferably 0 to 20% by mass. The content of the conductivity aid is within this range, and thus conductivity can be improved without the negative electrode capacity density being lowered.

The lithium-ion secondary battery negative electrode according to the present embodiment may include the binder. As the binder, the materials described in the first embodiment can be used.

Binders obtained by mixing the various types of organic binders described above and inorganic binders may be used. As the inorganic binder, the various types of materials described in the first embodiment can be used.

In the present embodiment, with the interface layer described above and formed by the use of the skeleton-forming agent, the negative electrode active material and the skeleton-forming agent are firmly bonded together, and thus all the binders described above can be used. When the total of the negative electrode active material, the binder and the conductivity aid contained in the negative electrode is assumed to be 100% by mass, a content of the binder is preferably 0.1 to 60% by mass. The content of the binder is within this range, and thus ion conductivity can be improved without the negative electrode capacity density being lowered, and a high mechanical strength and excellent cycle life characteristics are obtained. The content of the binder is more preferably 0.5 to 30% by mass.

The collector used in the lithium-ion secondary battery negative electrode according to the present embodiment is not particularly limited as long as the collector has electron conductivity and is a material capable of energizing the negative electrode active material which is held. For example, the various types of materials described in the first embodiment can be used.

In a conventional alloy-based negative electrode, the volume of a negative electrode material is significantly changed by charging and discharging, and thus it is considered that stainless steel or iron is preferable as the collector base material. However, in the present embodiment, stress applied to the collector can be suppressed with the skeleton-forming agent, and thus all the materials described above can be used.

### [Positive Electrode]

Although a positive electrode when the lithium-ion secondary battery is formed with the negative electrode described above (the negative electrode using the negative electrode material of the first embodiment or the negative electrode of the second embodiment) will then be described, since terms (such as the binder and the conductivity aid) common to the first and second embodiments are the same as in the first and second embodiments, they will be omitted as necessary unless otherwise described. A positive electrode active material is not particularly limited as long as the positive electrode active material is normally used in a lithium-ion secondary battery. For example, positive electrode active materials such as alkali metal transition metal oxide-based, vanadium-based, sulfur-based, solid solution-based (lithium excess-based, sodium excess-based and potassium excess-based), carbon-based and organic substance-based positive electrode active materials are used.

As with the negative electrode described above, the lithium-ion secondary battery positive electrode of the present embodiment may include a skeleton-forming agent. As the skeleton-forming agent, the same skeleton-forming agent as used in the negative electrode described above can be used, and the preferred content of the skeleton-forming agent is the same as in the negative electrode.

The lithium-ion secondary battery positive electrode of the present embodiment may include a conductivity aid. As the conductivity aid, the various types of conductivity aids which are described above and which can be used in the negative electrode are used. The preferred content of the conductivity aid is the same as in the negative electrode.

The lithium-ion secondary battery positive electrode of the present embodiment may include a binder. As the binder, a known material can be used, and, for example, one type of organic materials such as polyvinylidene fluoride (PVdF), polytetrafluoroethylene (PTFE), polyacrylic and alginic acid may be used singly or two or more types thereof may be used together. Binders obtained by mixing these organic binders and inorganic binders may be used. Although as the inorganic binder, for example, silicate-based, phosphate-based, sol-based, cement-based binders and the like are mentioned, the various types of materials described in the first and second embodiments can be used.

A collector used in the positive electrode is not particularly limited as long as the collector has electron conductivity and is a material capable of energizing the positive electrode active material which is held. For example, conductive substances such as C, Ti, Cr, Ni, Cu, Mo, Ru, Rh, Ta, W, Os, Ir, Pt, Au and Al and alloys (for example, stainless steel) containing two or more types of these conductive substances can be used. When a substance other than the conductive substances described above is used, for example, a multilayer structure of different metals such as a multilayer structure obtained by coating iron with Al may be used. In terms of high electrical conductivity and high stability in electrolytic liquid, C, Ti, Cr, Au, Al, stainless steel and the like are preferable as the collector, and furthermore, in terms of oxidation resistance and the material cost, C, Al, stainless steel and the like are preferable. Al coated with carbon and stainless steel coated with carbon are more preferable. The same shape of the collector as that of the collector used in the negative electrode can be used.

### [Separator]

In the lithium-ion secondary battery of the present embodiment, as a separator, a separator which is normally used in a lithium-ion secondary battery can be used. For example, as the separator, a glass non-woven fabric, an aramid non-woven fabric, a polyimide microporous membrane, a polyolefin microporous membrane and the like can be used.

### [Electrolyte]

In the lithium-ion secondary battery of the present embodiment, as the electrolyte, an electrolyte which is normally used in a lithium-ion secondary battery can be used. For example, an electrolytic liquid in which an electrolyte is dissolved in a solvent, a gel electrolyte, a solid electrolyte, an ionic liquid, a molten salt, a solid electrolyte and the like are mentioned. Here, the electrolytic liquid refers to a liquid in a state where an electrolyte is dissolved in a solvent.

As an electrolyte in a lithium-ion secondary battery, the electrolyte needs to contain lithium ions as a carrier responsible for electrical conductivity, and thus as the electrolyte salt thereof, a lithium salt is preferable though the electrolyte salt is not particularly limited as long as it is used in a lithium-ion secondary battery. As the lithium salt, at least one or more types selected from the group consisting of lithium hexafluorophosphate (LiPF₆), lithium perchlorate (LiClO₄), lithium tetrafluoroborate (LiBF₄), lithium trifluoromethanesulfonate (LiCF₃SO₄), lithium bistrifluoromethariesulfonylimide (LiN(SO₂CF₃)₂), lithium bispentafluoroethanesulfonylimide (LiN(SO₂C₂F₅)₂), lithium bisoxalate borate (LiBC₄O₈) and the like can be used or two or more types can be used together.

Although the solvent of the electrolyte is not particularly limited as long as the solvent is used in a lithium-ion secondary battery, at least one type selected from the group consisting of propylene carbonate (PC), ethylene carbonate (EC), dimethyl carbonate (DMC), diethyl carbonate (DEC), ethyl methyl carbonate (EMC), γ-butyrolactone (GBL), methyl-γ-butyrolactone, dimethoxymethane (DMM), dimethoxyethane (DME), vinylene carbonate (VC), vinylethylene carbonate (EVC), fluoroethylene carbonate (FEC), ethylenesulfite (ES) and the like can be used or two or more types can be used together.

Although the concentration of the electrolytic liquid (concentration of a salt in the solvent) is not particularly limited, the concentration is preferably 0.1 to 3.0 mol/L and further preferably 0.8 to 2.0 mol/L.

The types of cations (positive ions) in an ionic liquid and a molten salt are categorized as pyridine-based, alicyclic amine-based, aliphatic amine-based cations and the like. The types of anions (negative ions) which are combined with those described above are selected, and thus various ionic liquids and molten salts can be synthesized. Examples of the cation include ammonium-based ions such as imidazolium salts and pyridinium salts, phosphonium-based ions, inorganic-based ions and the like, and examples of the anion adopted include halogen-based ions such as a bromide ion and triflate, boron-based ions such as tetraphenylborate, phosphorus-based ions such as hexafluorophosphate and the like.

The ionic liquid and the molten salt can be obtained by a known synthesis method of combining, for example, a cation such as imidazolinium and an anion such as Br⁻, Cl⁻, BF⁴⁻, PF⁶⁻, (CF₃SO₂)₂N⁻, CF₃S³⁻ or FeCl⁴⁻. When the ionic liquid or the molten salt is used, it can function as an electrolytic liquid without addition of an electrolyte.

Solid electrolytes are categorized as sulfide-based, oxide-based, hydride-based, organic polymer-based electrolytes and the like. Most of these are amorphous or crystalline materials formed of a salt serving as a carrier and an inorganic derivative. Unlike an electrolytic liquid, it is not necessary to use a flammable aprotic organic solvent, and thus the ignition of a gas or liquid, the leakage of a liquid and the like are unlikely to occur, with the result that it is expected that a significantly safe secondary battery is provided.

### [Manufacturing Method]

### (Manufacturing Method in First Embodiment)

A method for manufacturing the non-aqueous electrolyte secondary battery according to the first embodiment will then be described.

In the method for manufacturing the non-aqueous electrolyte secondary battery negative electrode material according to the present embodiment, it is important to first bring the silicon-based material and the skeleton-forming agent liquid including the skeleton-forming agent into contact with each other. For example, the silicon-based material whose particle diameter is 1 μm and the skeleton-forming agent liquid are mixed together. Then, this mixed liquid is dried by a spray dry method and is thereafter classified, and thus the negative electrode material is obtained. Here, when the skeleton-forming agent liquid is a solid skeleton-forming agent, in the obtained negative electrode material, the interface layer is unlikely to be interposed between the silicon-based material and the skeleton-forming agent. Hence, the skeleton-forming agent is preferably a liquid.

When the conductivity aid is included in the skeleton-forming agent of the negative electrode material, a material in which the conductivity aid described above is dispersed in a silicate aqueous solution is preferably used.

The skeleton-forming agent liquid including the skeleton-forming agent can be manufactured by synthesizing an alkali metal silicate having a siloxane bond by a dry method or a wet method and performing water addition adjustment thereon. Here, a surfactant may be mixed. As a method for synthesizing the alkali metal silicate by the dry method, for example, SiO₂ is added into water in which an alkali metal hydroxide is dissolved and is treated in an autoclave at 150 to 250° C., and thus it is possible to manufacture the alkali metal silicate. As a method for synthesizing the alkali metal silicate by the wet method, for example, a mixture of an alkali metal carbonate compound and SiO₂ is burned at 1000 to 2000° C. and is dissolved in hot water, and thus it is possible to manufacture the alkali metal silicate.

Then, the skeleton-forming agent liquid is brought into contact with the surface of the silicon-based material so as to coat the silicon-based material. A method for bringing the silicon-based material and the skeleton-forming agent into contact with each other can be performed by adding the silicon-based material into a chamber in which the skeleton-forming agent liquid is stored. The skeleton-forming agent liquid makes contact with the surface of the silicon-based material so as to cover the surface of the silicon-based material. Then, the skeleton-forming agent is dried by heat treatment so as to be cured. In this way, the skeleton-forming agent forms the skeleton of the silicon-based material.

Since in the heat treatment described above, as its temperature is increased, the time of the heat treatment can be reduced and the strength of the skeleton-forming agent is improved, the temperature is preferably equal to or greater than 80° C., more preferably equal to or greater than 100° C. and desirably equal to or greater than 110° C. The upper limit temperature of the heat treatment is not particularly limited as long as the silicon-based material and the skeleton-forming agent do not react or decompose, and, for example, the temperature may be increased to about 1400° C., which is the melting point of silicon. Although in conventional granules, the upper limit temperature is estimated to be excessively lower than 1400° C. because a granulation aid may be carbonized, in the present embodiment, the inorganic skeleton-forming agent is used as the granulation aid, and thus the skeleton-forming agent has excellent heat resistance, with the result that the upper limit of the temperature is 1400° C.

With respect to the time of the heat treatment, the heat treatment can be performed by being held for 0.5 to 100 hours. Although the heat treatment may be performed in the atmosphere, the heat treatment is preferably performed under a non-oxidizing atmosphere so as to prevent the oxidation of the silicon-based material.

The negative electrode material obtained in this way is mixed together with the binder, and is applied and dried on the collector so as to form into the negative electrode. The negative electrode and the positive electrode described above are respectively cut to desired sizes, are joined through the separator and are sealed in a state where they are immersed in the electrolytic liquid, and thus it is possible to obtain the non-aqueous electrolyte secondary battery. The structure of the non-aqueous electrolyte secondary battery can be applied to the form or structure of an existing battery such as a multilayer battery or a winding battery.

### (Manufacturing Method in Second Embodiment)

A method for manufacturing a lithium-ion secondary battery according to the second embodiment will then be described. The manufacturing method is the same for the negative electrode and the positive electrode except that the collector and the active material which are used are different. Hence, only the method for manufacturing the negative electrode will be described, and the description of the method for manufacturing the positive electrode will be omitted.

In the method for manufacturing the lithium-ion secondary battery negative electrode according to the present embodiment, the negative electrode material is first applied to a copper foil. For example, while a 10 μm, thin rolled copper foil is manufactured and the copper foil which is previously wound in a roll shape is prepared, as the negative electrode material, silicon serving as the negative electrode active material, the binder, the conductivity aid and the like are mixed together to prepare slurry in paste form. Then, the negative electrode material in slurry form is applied to the surface of the copper foil and is dried, and thereafter pressure adjustment treatment is performed to obtain the precursor of the negative electrode.

As described above, the precursor of the negative electrode may be in a wet state without being dried. In addition to the slurry application described above, for example, a method for using a chemical plating method, a sputtering method, a vapor deposition method, a gas deposition method or the like so as to integrally form the negative electrode active material layer of the negative electrode active material (precursor) on the collector is mentioned. However, in terms of the lyophilic property of the skeleton-forming agent and an electrode manufacturing cost, the slurry application method is preferable.

On the other hand, the skeleton-forming agent liquid including the skeleton-forming agent is prepared. Specifically, the skeleton-forming agent liquid is manufactured by purifying an alkali metal silicate having a siloxane bond by a dry method or a wet method and performing water addition adjustment thereon. Here, a surfactant may be mixed. As the dry method, for example, SiO₂ is added into water in which an alkali metal hydroxide is dissolved and is treated in an autoclave at 150 to 250° C., and thus it is possible to manufacture an alkali metal silicate. As the wet method, for example, a mixture of an alkali metal carbonate compound and Sio₂ is burned at 1000 to 2000° C. and is dissolved in hot water, and thus it is possible to manufacture an alkali metal silicate.

Then, the skeleton-forming agent liquid is applied to the surface of the precursor of the negative electrode so as to coat the negative electrode active material. As a method for applying the skeleton-forming agent, in addition to a method for impregnating the precursor of the negative electrode in a chamber in which the skeleton-forming agent liquid is stored, a method for dropping or applying the skeleton-forming agent on the surface of the precursor of the negative electrode, spray application, screen printing, a curtain method, spin coating, gravure coating, die coating and the like can be performed. The skeleton-forming agent applied to the surface of the precursor of the negative electrode penetrates into the negative electrode so as to enter the gaps and the like of the negative electrode active material and the conductivity aid. Then, the skeleton-forming agent is dried by heat treatment so as to be cured. In this way, the skeleton-forming agent forms the skeleton of the negative electrode active material layer.

Since in the heat treatment described above, as its temperature is increased, the time of the heat treatment can be reduced and the strength of the skeleton-forming agent is improved, the temperature is preferably equal to or greater than 80° C., more preferably equal to or greater than 100° C. and desirably equal to or greater than 110° C. The upper limit temperature of the heat treatment is not particularly limited as long as the collector is not melted, and, for example, the temperature may be increased to about 1000° C., which is the melting point of copper. Although in a conventional electrode, the binder may be carbonized or the collector may be softened, and thus the upper limit temperature is estimated to be excessively lower than 1000° C., in the present embodiment, the skeleton-forming agent is used, and thus the skeleton-forming agent has excellent heat resistance and has a higher strength than the collector, with the result that the upper limit of the temperature is 1000° C.

With respect to the time of the heat treatment, the heat treatment can be performed by being held for 0.5 to 100 hours. Although the heat treatment may be performed in the atmosphere, the heat treatment is preferably performed under a non-oxidizing atmosphere so as to prevent the oxidation of the collector.

Finally, the negative electrode and the positive electrode obtained are respectively cut to desired sizes, are joined through the separator and are sealed in a state where they are immersed in the electrolytic liquid, and thus it is possible to obtain the lithium-ion secondary battery. The structure of the lithium-ion secondary battery can be applied to the form or structure of an existing battery such as a multilayer battery or a winding battery.

### [Effects]

According to the first and second embodiments, the following effects are achieved. In the first and second embodiments, the non-aqueous electrolyte secondary battery negative electrode material which includes the negative electrode active material formed of the silicon-based material, the skeleton-forming agent including the silicate having the siloxane bond and the interface layer formed in the interface between the negative electrode active material and the skeleton-forming agent and formed of the inorganic material, the non-aqueous electrolyte secondary battery negative electrode including the negative electrode material described above and the non-aqueous electrolyte secondary battery including the negative electrode described above are provided. In the first and second embodiments, in the interface between the silicon-based material and the skeleton-forming agent, the interface layer formed of the inorganic material joining both of them is formed, and thus the silicon-based material and the skeleton-forming agent are more firmly bonded together. Hence, peeling caused by the expansion and contraction of the silicon-based material at the time of charging and discharging and the occurrence of a wrinkle or a crack of the collector can be suppressed. Therefore, a high strength and excellent heat resistance are provided, and thus a battery life can be improved as compared with a conventional one.

In the present embodiment, the skeleton-forming agent includes the silicate represented by general formula (1) above, and the interface layer includes silicon and an alkali metal. It is estimated that as in the first and second embodiments, the negative electrode active material is formed of the silicon-based material and the skeleton-forming agent is formed of the silicate represented by general formula (1) above, that thus the silicon-based material forming the negative electrode active material and the silicate forming the skeleton-forming agent are melted together, for example, the hydrolyzed silicate is heated to undergo a hydration reaction (condensation reaction of silanol groups) so as to form a siloxane bond (—Si—O—Si) and that consequently, the interface layer is formed. Hence, it is estimated that a large amount of alkali metal generated, for example, by the hydrolysis of the silicate is included in the interface layer.

In particular, in the first and second embodiments, the ratio of the alkali metal atoms to all the constituent atoms of the interface layer is higher than the ratio of the alkali metal atoms to all the constituent atoms of the skeleton-forming agent, and is specifically three or more times as high as the ratio thereof, with the result that the effects described above are enhanced. In order to further enhance the effects, the ratio of the alkali metal atoms to all the constituent atoms of the interface layer is more preferably five or more times as high as the ratio thereof. Furthermore, the thickness of the interface layer is 3 to 30 nm, and thus the effects described above are further enhanced.

The present invention is not limited to the embodiments described above, and variations and modifications are included in the present invention as long as the object of the present invention can be achieved. For example, the non-aqueous electrolyte secondary battery which is a secondary battery (electricity storage device) using, as its electrolyte, a non-aqueous electrolyte such as an organic solvent includes, in addition to a lithium-ion secondary battery, a sodium-ion secondary battery, a potassium-ion secondary battery, a magnesium-ion secondary battery, a calcium-ion secondary battery and the like. The lithium-ion secondary battery means a non-aqueous electrolyte secondary battery whose main component is not water and a battery which includes lithium ions as a carrier responsible for electrical conductivity. For example, the lithium-ion secondary battery, a metal lithium battery, a lithium-polymer battery, a lithium all-solid-state battery, an air lithium-ion battery and the like apply. The same is true for other secondary batteries. Here, the non-aqueous electrolyte whose main component is not water means that the main component in the electrolyte is not water. In other words, it is a known electrolyte used in the non-aqueous electrolyte secondary battery. This electrolyte can function as a secondary battery though it includes a small amount of water but this adversely affects the cycle characteristics, the storage characteristics and input/output characteristics of the secondary battery, and thus the electrolyte in which water is minimized is desirable. The amount of water in the electrolyte is realistically preferably equal to or less than 5000 ppm.

### EXAMPLES

Although Examples of the present invention will then be described, the present invention is not limited to these Examples.

### Examples 1 to 4, Comparative Examples 1 to 6

Slurries which included, at a solid content ratio, 92% by mass of negative electrode active materials shown in table 1, 4% by mass of acetylene black (AB) serving as a conductivity aid and 4% by mass of polyvinylidene fluoride (PVdF) serving as a binder were individually prepared. Then, the prepared slurries were applied to a copper foil serving as a collector and were dried, and thereafter pressure adjustment treatment was performed to obtain the precursors of negative electrodes.

On the other hand, skeleton-forming agent liquids including skeleton-forming agents shown in table 1 and water were prepared. The precursors of the negative electrodes obtained as described above were immersed in the prepared skeleton-forming agent liquids. Then, after the immersion, the precursors of the negative electrodes were heated at respective heat treatment temperatures shown in table 1 and were dried, and thus the negative electrodes were obtained. The mass ratios of the skeleton-forming agents in the obtained negative electrodes were 0.15 to 0.41 mg/cm.

As the opposite electrode of the negative electrode, a lithium metal foil (thickness of 500 μm) was used. As a separator, a glass non-woven fabric was used, and an electrolytic liquid (1.1 M LiPF₆/(EC:EMC:DEC=3:4:3 vol.)) in which lithium hexafluorophosphate (LiPF₆) serving as an electrolyte was dissolved in ethylene carbonate (EC)/ethyl methyl carbonate (EMC)/diethyl carbonate (DEC) serving as an organic solvent was used so as to produce a lithium-ion secondary battery.

TABLE 1

| | | | Skeleton-forming agent | | Interface layer | | | |
|---|---|---|---|---|---|---|---|---|
| | | Skeleton- | | | | | Heat | |
| | | forming | | Alkali | Alkali | | treat- | |
| | Negative | agent | | metal | metal | | ment | Capacity |
| | electrode | mass | | atom | atom | Thick- | temper- | (50 |
| | active | ratio | | ratio | ratio | ness | ature | cycle) |
| | material | (mg/cm²) | Composition | (%) | (%) | (nm) | (° C.) | (mAh/g) |
| Example 1 | Si | 0.15 | K₂O · 3SiO₂ | 0.1 | 1.7 | 18 | 160 | 2016 |
| Example 2 | Si | 0.27 | Na₂O · 3SiO₂ | 0.2 | 1.7 | 20 | 300 | 1890 |
| Example 3 | Si | 0.28 | Na₂O · 3SiO₂ | 0.2 | 1.5 | 10 | 150 | 1862 |
| Example 4 | Si | 0.25 | K₂O · 3SiO₂ | 0.3 | 1.4 | 15 | 300 | 1431 |
| Comparative | Si | — | — | — | — | — | — | 0.6 |
| Example 1 | | | | | | | | |
| Comparative | SiO | 0.33 | K₂O · 3SiO₂ | 0.2 | 0.4 | 40 | 160 | 1210 |
| Example 2 | | | | | | | | |
| Comparative | SiO | 0.37 | Na₂O · 3SiO₂ | 0.3 | 0.5 | 35 | 150 | 1223 |
| Example 3 | | | | | | | | |
| Comparative | Graphite | 0.41 | Na₂O · 3SiO₂ | 0.3 | 0.4 | 30 | 150 | 370 |
| Example 4 | | | | | | | | |

### [TEM Observation, EDX Measurement]

An enlargement observation was performed with a TEM (transmission electron microscope) on the negative electrodes of Examples and Comparative Examples. The TEM observation was performed on an approximately 15 nm square region, and thus whether or not an interface layer was present and the thickness of the interface layer were checked. An elemental analysis was performed by EDX (Energy Dispersive X-ray Spectroscopy) while the TEM observation was being performed, and thus the ratio (mass % with respect to all constituent atoms) of alkali metal atoms in each of the active material, the interface layer and the skeleton-forming agent was determined from the peak intensity of an EDX spectrum and was shown in table 1. In addition, an element mapping measurement was performed by EDX. As a device, an aberration correction scanning transmission electron microscope “Titan3 G2 60-300” made by FEI Company Japan Ltd. was used to perform the observation at a magnification of 1300 K with an acceleration voltage of 300 kV. For processing on samples, PIPS was used, the negative electrodes were reinforced with a Mo ring and milling was performed. Ion beam energy at the time of processing was set to 5 kV, and ion beam energy at the time of finishing was set to 3 kV.

### [Cycle Life Test]

A cycle life test was performed on the negative electrodes of Examples and Comparative Examples. The cycle life test was performed under conditions in which a test environment temperature was 25° C., a current density was 0.2 C-rate and a cutoff potential was 0.01 to 1.5 V (vs. Li+/Li). The results thereof are shown in table 1.

### [Considerations]

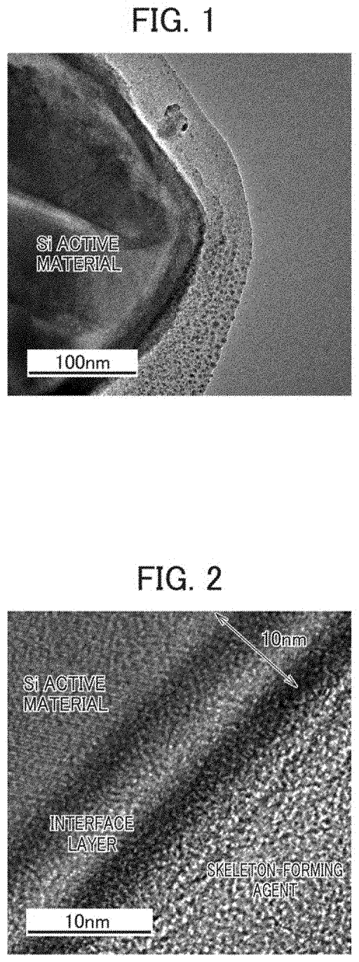

FIG. 1 is a TEM image of the negative electrode in Example 3. FIG. 2 is an enlarged view of the interface between the negative electrode active material and the skeleton-forming agent in FIG. 1. It was confirmed from the TEM images of FIGS. 1 and 2 that in the interface between the negative electrode active material and the skeleton-forming agent, the interface layer joining the negative electrode active material and the skeleton-forming agent was formed. It was also confirmed from FIG. 2 that the thickness of the interface layer was 10 nm. Although only the TEM image of the negative electrode in Example 3 was shown as a typical example, the same interface layers were confirmed in all the other Examples.

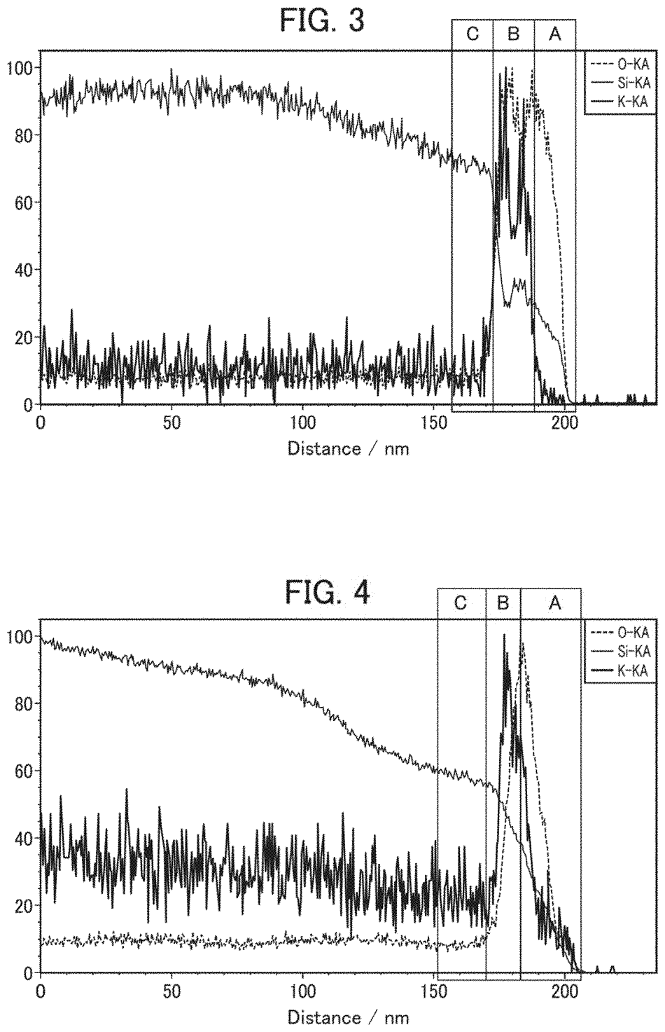

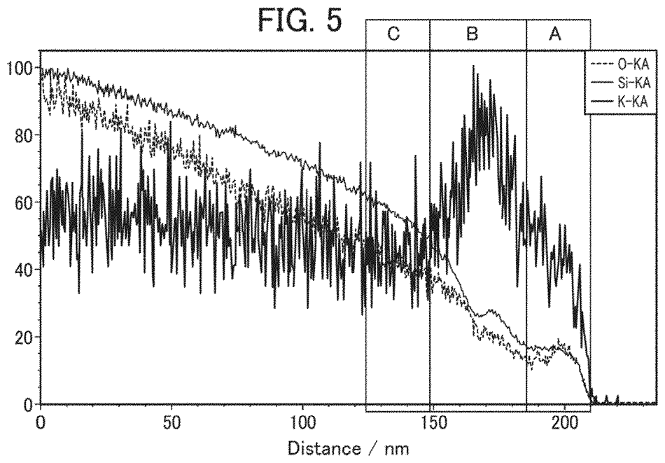

FIG. 3 is an EDX spectrum diagram of the negative electrode in Example 1. FIG. 4 is an EDX spectrum diagram of the negative electrode in Example 4. FIG. 5 is an EDX spectrum diagram of the negative electrode in Comparative Example 4. FIGS. 3 to 5 show the EDX spectra of oxygen, silicon and potassium resulting from the EDX measurements. In the figures, a region A indicates the skeleton-forming agent, a region C indicates the negative electrode active material and a region B indicates the interface between the negative electrode active material and the skeleton-forming agent. It was found from FIGS. 3 and 4 that in the region B indicating the interface between the negative electrode active material and the skeleton-forming agent, a content of potassium was high and silicon was contained. It was estimated from these results that the silicon forming the negative electrode active material and the alkali metal salt of silicic acid forming the skeleton-forming agent were melted together, for example, the hydrolyzed silicate was heated to undergo a hydration reaction (condensation reaction of silanol groups) so as to form a siloxane bond (—Si—O—Si), and that thus the interface layer was formed. By contrast, in FIG. 5, in the region B indicating the interface between the negative electrode active material and the skeleton-forming agent, all contents of potassium, silicon and oxygen were equal to or less than detection lower limits.

As typical examples, the ratios of the alkali metal atom (potassium) in the active material, the interface layer and the skeleton-forming agent of the negative electrode in Example 1 are shown in table 2. As shown in table 2, it was confirmed that the mass ratio of potassium to all the constituent atoms in the interface layer was 1.7%, and was higher than 0.1% which was the mass ratio of potassium to all the constituent atoms in the skeleton-forming agent so as to be three or more times as high as the mass ratio thereof. It was confirmed that in all the other Examples where the interface layers were confirmed by the TEM observation, as shown in table 1, the same tendency was provided.

TABLE 2

| | Negative | | |
|---|---|---|---|
| | electrode | | |
| | active | Interface | Skeleton |
| Atom | material | layer | forming agent |
| Si (atm %) | 93.8 | 43.9 | 37.8 |
| O (atm %) | 6 | 54.4 | 62.1 |
| K (atm %) | 0.2 | 1.7 | 0.1 |

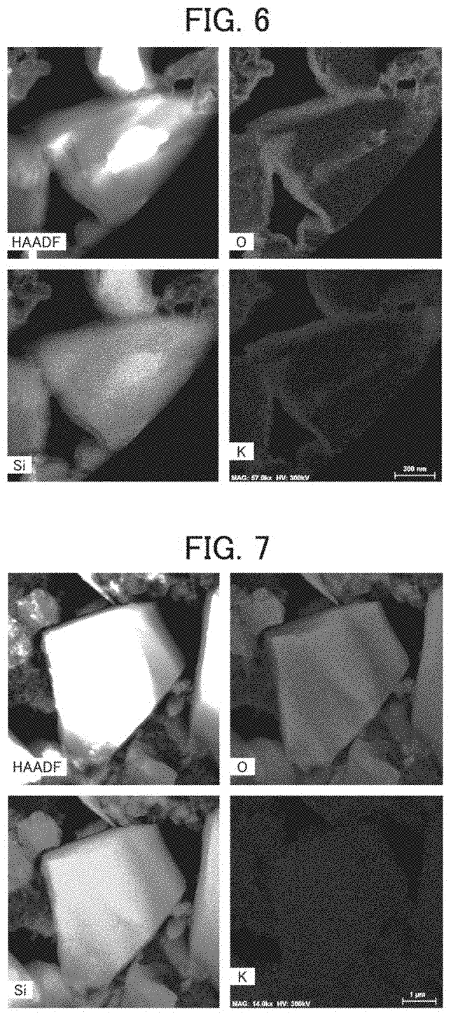

FIG. 6 is an EDX mapping diagram of the negative electrode in Example 1. FIG. 7 is an EDX mapping diagram of the negative electrode in Comparative Example 4. FIGS. 6 and 7 show the TEM images of the negative electrodes and the distributions of oxygen, silicon and potassium in the EDX mapping measurements of regions of field of view corresponding to the TEM images. As shown in FIG. 6, it was found that in the negative electrode of Example 1, a large amount of potassium was present in the interface between the negative electrode active material and the skeleton-forming agent. By contrast, it was found that in the negative electrode of Comparative Example 4, the amount of potassium element was low as a whole, and that a large amount of potassium was not present in the interface between the negative electrode active material and the skeleton-forming agent. Hence, as a result, in the present Example, it was confirmed that the interface layer including potassium, which was an alkali metal, was formed in the interface between the negative electrode active material and the skeleton-forming agent.

As described above, in the present Example, it was confirmed that in the interface between the negative electrode active material and the skeleton-forming agent, the interface layer was formed which included a large amount of inorganic material joining both of them, that is, alkali metal as compared with a skeleton-forming agent region and which joined the negative electrode active material and the skeleton-forming agent with the siloxane bond, that thus a large capacity was obtained in a cycle life test as shown in table 1 and that therefore the battery life was improved.

More specifically, as is clear from table 1, it was confirmed that in Examples 1 to 4 where the ratio of the alkali metal atoms in the interface layer was three or more times as high as the ratio of the alkali metal atoms in the skeleton-forming agent, as compared with Comparative Examples 1 to 4 where the ratio of the alkali metal atoms in the interface layer was less than three times as high as the ratio of the alkali metal atoms in the skeleton-forming agent, a large capacity was obtained in the cycle life test and that thus the battery life was improved. In particular, it was confirmed that in Examples 1 to 3 where the ratio of the alkali metal atoms in the interface layer was five or more times as high as the ratio of the alkali metal atoms in the skeleton-forming agent, a large capacity was obtained in the cycle life test and that thus the battery life was more improved. It was also found from the results of Examples 3 and 4 that, when potassium was included as the skeleton-forming agent, the temperature of heat treatment was set to a high temperature (300° C.), and that thus the cycle life test was degraded.

What is claimed is:

1. A non-aqueous electrolyte secondary battery negative electrode material comprising:
a negative electrode active material formed of a silicon-based material;
a skeleton-forming agent including a silicate having a siloxane bond; and
an interface layer formed in an interface between the negative electrode active material and the skeleton-forming agent and formed of an inorganic material.

2. The non-aqueous electrolyte secondary battery negative electrode material according to claim 1, wherein the skeleton-forming agent includes the silicate represented by general formula (1) below, and
the interface layer includes silicon and an alkali metal.
[Chem. 1]
A₂O.nSiO₂ formula (1)
[In the general formula (1) above, A represents an alkali metal.]

3. The non-aqueous electrolyte secondary battery negative electrode material according to claim 1, wherein a ratio of alkali metal atoms to all constituent atoms of the interface layer is higher than a ratio of alkali metal atoms to all constituent atoms of the skeleton-forming agent.

4. The non-aqueous electrolyte secondary battery negative electrode material according to claim 3, wherein the ratio of the alkali metal atoms to all the constituent atoms of the interface layer is three or more times as high as the ratio of the alkali metal atoms to all the constituent atoms of the skeleton-forming agent.

5. The non-aqueous electrolyte secondary battery negative electrode material according to claim 1, wherein a thickness of the interface layer is 3 to 30 nm.

6. A non-aqueous electrolyte secondary battery negative electrode comprising the non-aqueous electrolyte secondary battery negative electrode material according to claim 1.

7. A non-aqueous electrolyte secondary battery comprising the non-aqueous electrolyte secondary battery negative electrode according to claim 6.
